(19) United States
(12) Patent Application Publication
(10) Pub. No.: US 2025/0216280 A1
(43) Pub. Date: Jul. 3, 2025

(54) PRESSURE MEASURING MODULE FOR A PNEUMATIC DEVICE OF A VEHICLE

(71) Applicant: ZF CV Systems Europe BV, Brussels (BE)

(72) Inventors: Timo Denker, Hannover (DE); Joachim Hein, Hannover (DE)

(21) Appl. No.: 18/851,296

(22) PCT Filed: Feb. 20, 2023
(86) PCT No.: PCT/EP2023/054121

§ 371 Date: Sep. 26, 2024

(30) Foreign Application Priority Data
Mar. 29, 2022 (DE) 10 2022 107 409.9

(51) Int. Cl. G01L 19/14; F15B 19/00; G01L 9/00; G01L 19/00; G07C 5/08

(52) U.S. Cl. CPC G01L 19/142; F15B 19/00; G01L 9/0052; G01L 19/0038; G01L 19/0084; G07C 5/0808

(57) ABSTRACT

A pressure measuring module (1) for a pneumatic device (2) includes a pressure sensor (20), a mechanical interface (4), a pneumatic interface (26), and an electrical interface (30), by way of which an electrical pressure measuring signal generated by the pressure sensor can be passed on. The mechanical interface has a plate-shaped carrier (5), on which the pressure sensor is arranged, the pneumatic interface is arranged on a first carrier side (15), and is provided with a sealing means (27), and the electrical interface is arranged on a second carrier side (16). The electrical interface has an electrical spring contact device (31), and the electrical interface can be electrically connected to an electronic control device of the pneumatic device directly or by way of an adapter (35, 40).

### FIELD

The present disclosure relates to a pressure measuring module for a pneumatic device of a vehicle, with a pressure sensor, with a mechanical interface, by way of which the pressure sensor can be mechanically connected to the pneumatic device directly or indirectly, with a pneumatic interface, by way of which a pneumatic pressure of the pneumatic device can be recorded by way of the pressure sensor, and with an electrical interface, by way of which an electrical pressure measuring signal concerning the recorded pneumatic pressure and generated by the pressure sensor can be passed on. The present disclosure also relates to a pneumatic device of a vehicle with such a pressure measuring module.

### BACKGROUND

Pneumatic pressure sensors are used in compressed-air systems of vehicles, for example in commercial vehicles with air suspension systems, pneumatic brake systems and/or pneumatically switchable automated manual transmissions, for monitoring and pneumatically actuating these systems. In commercial vehicles, which in any case have a compressed-air supply device, the automated manual transmission, assigned friction clutches and possibly a transmission brake can often be actuated by way of an electropneumatic switching device. The selecting and switching operations in the manual transmission itself then take place by way of pneumatic selecting and switching actuators that are operative in two directions. One or more pneumatic pressure sensors are required for controlling such electropneumatic switching devices.

Electropneumatic switching devices in commercial vehicles are known in various structural configurations with various kinds of contact techniques for mechanically and functionally connecting pressure sensors, for example by way of cable connections, flex film connections or circuit board connections. However, the various kinds of widespread contact techniques require a pressure sensor respectively adapted to it. Often, special tools are required for fitting them. This results in high cost expenditure. Moreover, in the case of some kinds of contact techniques, exchange of a pressure sensor once fitted is not readily possible or involves considerable effort, which is considered to be unfavorable.

DE 10 2019 126 526 A1 discloses a pressure sensor for use in an external component, in particular for use in a valve block of an air suspension system of a vehicle. The pressure sensor has a sensor housing, in or on which a pressure measuring cellar is arranged, and also a circuit board, which is arranged completely or partially on an outer side of the sensor housing and is securely connected to the sensor housing. The circuit board has a multiplicity of contact pads or contact areas for external electrical contacting of the circuit board. Apart from this electrical interface, the sensor housing also has pneumatic and mechanical interfaces. For example, the sensor housing has as a pneumatic interface a cylindrical connector with one or more O-rings arranged on a radial and/or axial outer surface of the connector. The connector is appropriately formed for positioning the pressure sensor in a corresponding receptacle, for example for insertion into a bore of the external component or of the valve block. As a mechanical interface, the sensor housing has retaining features, for example in the form of elevations, depressions, detent lugs and/or threads, which interact with corresponding retaining features of the external component or of the valve block in order to fix the pressure sensor on this external component or the valve block. In this case, the mechanical retaining features of the sensor housing of the pressure sensor may be arranged completely or partially on the connector.

A disadvantage of this known pressure sensor is that a circuit board with contact pads is prescribed for the electrical contacting of the pressure sensor. Therefore, a corresponding counterpart must for example be present on a component of an electropneumatic switching device of an automated manual transmission, or be arranged for it, and this can cause additional cost expenditure. In particular in the case of inserted electrical contacting of such a pressure sensor with a circuit board on a valve block or on a gear actuator of a commercial vehicle, the contact pads mentioned are not well suited for undisturbed electrical signal transmission because of the comparatively strong vibrations occurring during operation. If, as an alternative to this, electrical leads are to be soldered onto the contact pads, this disadvantageously represents an additional working step. Quick and easy exchangeability of such a soldered-on pressure sensor in the event of a defect is also not possible.

### SUMMARY

Against this background, the present disclosure is based on the object of presenting a pressure measuring module with a pressure sensor of the type mentioned at the beginning which can be easily adapted to a pneumatic device of a vehicle, and which is also inexpensive to produce. In particular, such a pressure measuring module is intended to be suitable for use on a pneumatically actuable automated manual transmission of a vehicle.

This object is achieved by the features of the present disclosure, while advantageous refinements and developments of the present disclosure are described herein.

The present disclosure is accordingly based on a pressure measuring module for a pneumatic device of a vehicle, with a pressure sensor, with a mechanical interface, by way of which the pressure sensor can be mechanically connected to the pneumatic device directly or indirectly, with a pneumatic interface, by way of which a pneumatic pressure of the pneumatic device can be recorded by way of the pressure sensor, and with an electrical interface, by way of which an electrical pressure measuring signal concerning the recorded pneumatic pressure and generated by the pressure sensor can be passed on.

For achieving the stated object with regard to creating a pressure measuring module, the present disclosure provides that the mechanical interface has a plate-shaped carrier, on which the pressure sensor is arranged, that the carrier has at least a first retaining feature for mechanically connecting the carrier to assigned retaining features of the pneumatic device, that the first retaining feature has at least two extensions, formed on the carrier and respectively provided with a through-bore, that the extensions of the carrier are arranged at a distance from one another and from the pressure sensor, that the pneumatic interface is arranged on a first carrier side, that the pneumatic interface protrudes from the first carrier side and is provided with a sealing feature in such a way that, when mechanically connecting the carrier to the pneumatic device, a pressure-tight connection of the pneumatic interface to the pneumatic device can be established, that the electrical interface is arranged on a second carrier side, which is opposite from the first carrier side, that the electrical interface has an electrical spring contact device, which protrudes from the second carrier side and has at least one electrical contact spring formed as a compression spring, and that the electrical interface can be electrically connected to an electronic control device of the pneumatic device directly or indirectly by way of an adapter. In a preferred embodiment, the electrical interface has an electrical spring contact device, which protrudes from the second carrier side and has three electrical contact springs formed as compression springs. In this preferred embodiment, at least one of the three electrical contact springs formed as compression springs is formed as a signal path between the pressure measuring module and an electrical circuit, which is not part of the pressure measuring module.

This arrangement of a pressure measuring module has the effect of creating a simple pneumatic pressure measuring device which can be adapted with little effort to various structural conditions of a component of a pneumatic device of a vehicle. The pressure measuring module is particularly advantageously suited for use in an electropneumatic switching device of a pneumatically actuable automated manual transmission. The pressure measuring module may however also be advantageously used in other pneumatic devices, such as for example in a pneumatic ride-height control of an air suspension system or in a pneumatic brake system. The arrangement according to the present disclosure of the mechanical, pneumatic, and electrical interfaces allows the pressure measuring module to be used highly flexibly. The pressure measuring module is also advantageously constructed as robust and resistant to vibrations. In particular, it can be used with simple and inexpensive spring contacts in various applications that require different contact techniques.

The mechanical interface of the pressure measuring module allows easy attachment via screwing to the assigned component of a pneumatic device. By way of the sealing feature of the pneumatic interface, for example a simple O-ring, which can be placed into a groove surrounding a pneumatic opening, a secure pressure-tight connection of the pressure sensor to the pneumatic device can be easily established. The electrical interface is formed according to the present disclosure as a spring contact device which allows easy electrical contacting of the pressure sensor. In particular, it is not restricted to specific mating contacts. In any event, the pressure measuring module according to the present disclosure allows an easy and cost-saving possibility of pneumatic pressure recording, without a complex design adaptation in each case to the structural specifications of the respective producer of the pneumatic device being required.

According to a first development of the pressure measuring module according to the present disclosure, it is provided that the electrical spring contact device is arranged off-center on the second carrier side, and that the spring contact device has three electrical contact springs, which are arranged in the shape of a triangle and are formed as helical compression springs or spiral compression springs and which in their axial extent protrude from the second carrier side.

This arrangement of electrical compression springs allows an easy, direct electrical connection to an electrical mating contact area of an electronic control device or similar electrical device. For example, the pressure measuring module may be fitted directly in a circuit board frame or on a circuit board. An electrical connection of the spring contact device to a suitably formed adapter can be established similarly easily. The adapter may then have for example an electrical cable connection or a circuit board with contact pads in order to establish an electrical connection to an electronic control device or the like.

According to a second development of the pressure measuring module according to the present disclosure, it is provided that the carrier has a second retaining feature for optionally mechanically connecting the carrier to retaining features of an adapter for the electrical interface, that the second retaining feature has at least two detent pins or similar connecting elements, which are arranged at a distance from one another and from the pressure sensor, with the mechanical connecting of the carrier to the adapter by way of the second retaining feature having the consequence that at the same time an electrical connection of the electrical interface to the adapter is established.

Accordingly, the carrier may have simple detent or snap elements, on which an adapter with corresponding mating detent elements can be locked or snapped into place. The carrier may for example be produced as a plastic injection-molded part on which the corresponding retaining features are molded. The second retaining feature or the detent or snap elements serve at least for aligning the pressure measuring module according to the present disclosure properly in place during an attaching operation, for example on a valve block or the like, to allow subsequent unskewed screwing of the pressure measuring module to the valve block or the like. The detent or snap elements and their mating elements may however also be formed so precisely and stiffly that, given an attachment location where there is no vibration or little vibration during operation, a sufficiently good mechanical, pneumatic and electrical connection can be established by these elements alone.

According to another embodiment, it may be provided that a first adapter is formed as a transmitter connection, that the first adapter has a cover, which can be fastened on the second retaining feature of the carrier, and that a pressure signal transmitter which is electrically connected to the electrical spring contact device in the fitted state is integrated in the cover.

As a result, the pressure measuring module can advantageously act as an electrical or electromagnetic transmitting part by way of which the electrical pressure signal of the recorded pneumatic pressure can be transmitted in a wire-bound or wireless manner to an electronic control device or the like.

It may also be provided that a second adapter is formed as a plug connection, that the second adapter has a plate, which can be fastened on the second retaining feature of the carrier, that the plate has an extension extending geometrically beyond the carrier, that an electrical plug-in contact device is arranged on the extension, that the plug-in contact device has at least a number of electrical plug-in contacts corresponding to the number of electrical contact springs of the spring contact device, and that in the fitted state in each case at least one plug-in contact is electrically connected to a contact spring.

As a result, the pressure measuring module can advantageously act as a plug part by way of which the electrical pressure signal of the recorded pneumatic pressure can be transmitted by way of a corresponding mating plug, for example a plug of a cable harness, to an electronic control device or the like.

The adapters mentioned should be understood merely as examples. Depending on the specifications and structural conditions of the pneumatic device concerned, a person skilled in the art may devise further adapters which are compatible with the pressure measuring module according to the present disclosure.

According to a further embodiment of the pressure measuring module, it is provided that the pressure sensor is formed as a piezoelectric microsensor with a pressure-sensitive piezoresistive membrane and with evaluation electronics, that the evaluation electronics are electrically connected to the electrical spring contact device, and that the membrane is pneumatically connected to the pneumatic interface.

The pressure sensors that are used here are available on the market in various configurations as pressure measuring devices for pneumatic pressure measurements. On account of their compact structural form and their sensitive response, they are particularly advantageously suited for use and integration in a pressure measuring module according to the present disclosure.

It may also be provided that the pressure sensor is exchangeably fastened on the carrier as a module part. This makes it possible to fit carriers that are different with regard to their geometry with different pressure sensors in order in this way to create pressure measuring modules which are suitable for the respective application. The mechanical connection between the pressure sensor and the carrier may take place for example by detent locking, in particular when operation without vibration or with little vibration can be presupposed.

Finally, the present disclosure also relates to a pneumatic device of a vehicle which serves for the actuation of switching actuators and or selecting actuators of an automated manual transmission, with an electropneumatic switching device and with a pressure measuring module for recording a pneumatic pressure of the switching device, with the pressure measuring module being constructed according to one of the device claims, and also to a vehicle, such as a commercial vehicle or passenger car, with the pressure measuring module being constructed according to the present disclosure.

### BRIEF DESCRIPTION OF THE DRAWINGS

The present disclosure is explained in more detail below on the basis of exemplary embodiments represented in the appended drawings, in which:

FIG. 1 shows a perspective view of a pressure measuring module according to the present disclosure from obliquely above,

FIG. 2 shows a perspective view of the pressure measuring module according to FIG. 1 from below,

FIG. 3 shows a perspective side view of the pressure measuring module according to FIG. 1,

FIG. 4 shows a view of the pressure measuring module in an axial section,

FIG. 5 shows a perspective partial view of the pressure measuring module with an axial section,

FIG. 6 shows another perspective partial view of the pressure measuring module in axial section,

FIG. 7 shows a perspective view of a first adapter for a pressure measuring module according to FIG. 1 from obliquely above,

FIG. 8 shows a perspective view of the adapter according to FIG. 7 from below,

FIG. 9 shows a perspective view of a second adapter for a pressure measuring module according to FIG. 1 from above, and

FIG. 10 shows a perspective view of the adapter according to FIG. 9 from below.

Some structural elements in the figures coincide, and so are denoted by the same reference numerals.

### DETAILED DESCRIPTION

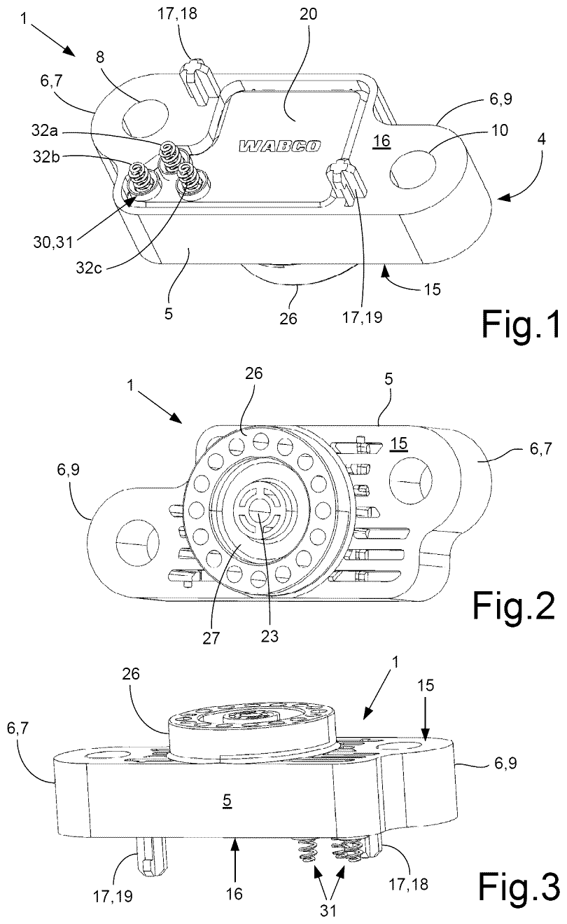

Accordingly, FIGS. 1 to 6 show a pressure measuring module 1, represented in various views, of a pneumatic device 2. The pneumatic device 2 may be for example an actuator system for selecting and/or switching gears of an automated manual transmission. The selecting and switching operations in the manual transmission itself take place in a known way by way of pneumatic actuators which are formed as piston-cylinder arrangements.

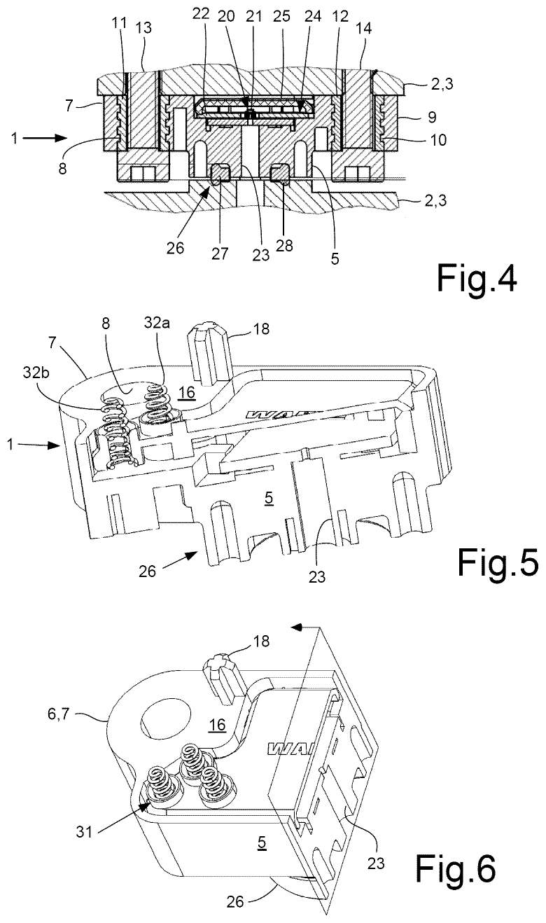

For controlling and monitoring the electropneumatic switching device, one or more pressure sensors are required. Such manual transmissions are known. All that is important here is the pressure measuring module 1 proposed by the present disclosure. One or more of these pressure measuring modules 1 may be fitted on such a manual transmission or on its electropneumatic switching device. FIG. 4 shows such a pressure measuring module 1 in the installed state on a merely indicated pneumatic device 2, here in the installed state on a transmission actuator of an automated manual transmission. The construction of a pressure measuring module 1 according to the present disclosure is explained in more detail below.

Accordingly, the pressure measuring module 1 has a mechanical interface 4 on a plate-shaped carrier 5. The carrier 5 is produced for example as a plastic injection-molded part. Formed on the carrier 5 is a first retaining feature 6 for producing a secure connection to the pneumatic device 2. The first retaining feature 6 includes a first extension 7 with a first through-bore 8 and a second extension 9 with a second through-bore 10. The two extensions 7, 9 are formed diametrically opposed in the plane of the carrier and offset in relation to one another on the short end faces of the carrier 2, on its plastic body.

FIG. 4 shows an axial section through the two extensions 7, 9 of the carrier 5. As can be seen in FIG. 4, the two through-bores 8, 10 may be additionally lined in each case with a sleeve 11, 12 and serve for receiving in each case a threaded screw 13, 14. With the threaded screws 13, 14, the carrier 5 can then be securely screwed to corresponding threaded bores (not shown) on the pneumatic device 2.

Also arranged on the carrier 5, on its second carrier side 16 shown in FIGS. 1, 5 and 6 in the viewing direction from obliquely above, is a second retaining feature 17. The second retaining feature 17 is in the form of a first detent pin 18 and a second detent pin 19, which are provided for detent locking with an adapter 35, 40 described in more detail later.

Integrated in the carrier 5 as a central component part of the pressure measuring module 1 is a pressure sensor 20. The construction of the pressure sensor 20 can be seen best in FIG. 4. Accordingly, the pressure sensor 20 in the present example is formed as a so-called MEMS sensor. This is a compact microsensor with a centrally arranged elastic membrane 21, on the surface of which multiple piezoresistors interconnected to form a Wheatstone bridge are arranged and securely connected to the membrane. The membrane 21 is integrated in a circuit board 22 with evaluation electronics 24, which record and evaluate the signals of the Wheatstone bridge. The membrane 21 sits at the end of a pneumatic opening 23 or bore in the carrier 5, forming a pneumatic connection to the pneumatic device 2. The circuit board 22 is covered by a covering 25 for protection in the upward direction.

The pneumatic opening 23 is part of a pneumatic interface 26 of the pressure measuring module 1. The pneumatic interface 26 can be seen in full in the perspective views of FIG. 2 and FIG. 3 and in section in FIG. 5 and FIG. 6. Accordingly, the pneumatic interface 26 is formed as a cylindrical body which axially protrudes on one side out of the first carrier side 15 of the carrier 5 seen in the viewing direction from below. Arranged at its free end is a pneumatic sealing feature 27 formed as an O-ring, which has been placed in a groove 28 of the carrier 5 and annularly surrounds the opening 23. The arrangement of the sealing feature 27 has the effect that the pressure measuring module 1 or the pressure sensor 20 is connected to the pneumatic device 1 or to a pneumatic bore of this device as outwardly sealed off. Screwing, clamping or hooking connecting features that are not shown here may be provided for the mechanical connection of the pneumatic interface 26 to the pneumatic device 2.

The pressure measuring module 1 also has an electrical interface 30. The electrical interface 30 is arranged on the second carrier side 16, that is to say the upper side in the viewing direction. The electrical interface 30 has an electrical spring contact device 31, which protrudes axially on the second carrier side 16. In the present example, the spring contact device 31 includes an ensemble of three electrical contact springs 32a, 32b, 32c, which are formed as helical compression springs. For better contacting, the contact springs 32a, 32b, 32c may be coated with an electrically highly conductive gold layer or silver layer. The electrical spring contact device 31 is electrically connected to the evaluation electronics 24 of the pressure sensor 20, and so the electrical pressure signal can be picked off at the electrical spring contact device 31.

If the elastic membrane 21 of the pressure sensor 20 is exposed to a change in pressure of the pneumatic device 2, and as a result stretches to a greater or lesser extent, a change in electrical voltage proportional to the change in pressure is produced at the Wheatstone bridge. The electrical voltage signal or pressure signal can be picked off directly at the electrical spring contact device 31 by way of a corresponding electrical connection of a control device 3 of the pneumatic device 2. As an alternative to this, an adapter may be interposed.

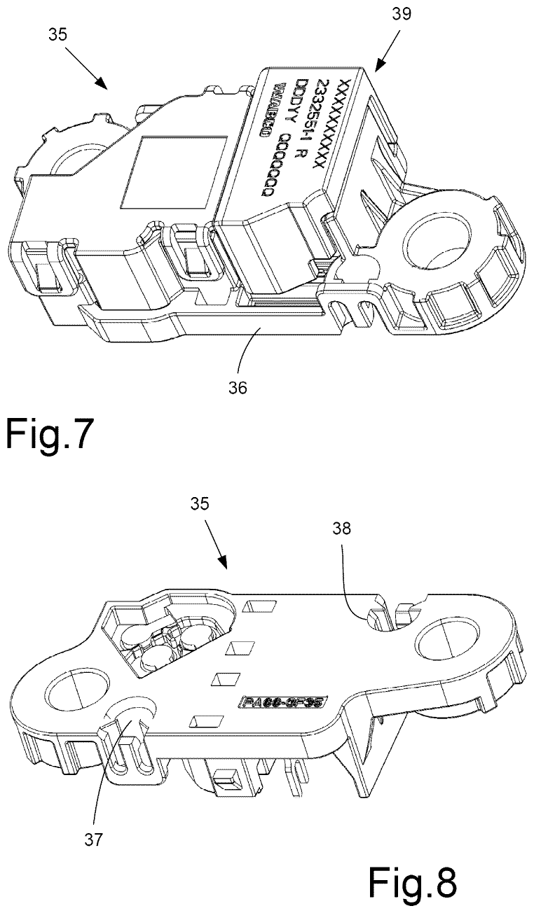

Two suitable adapters are described in more detail by way of example below: accordingly, FIGS. 7 and 8 show a first adapter 35. This first adapter 35 has a cover 36, which can be placed onto the carrier 5 and locked in place on the detent pins 18, 19 by way of the second retaining feature 17. For this purpose, two assigned receptacles 37, 38 for the detent pins 18, 19 are formed on the cover 36. Arranged on the cover 36 is a pressure signal transmitter 39, which in the fitted state is electrically connected to the electrical spring contact device 31 of the pressure sensor 20. By way of the pressure signal transmitter 39, the measuring signal can be picked off, for example in a wireless manner, and be made available for example on a data bus system such as a CAN bus.

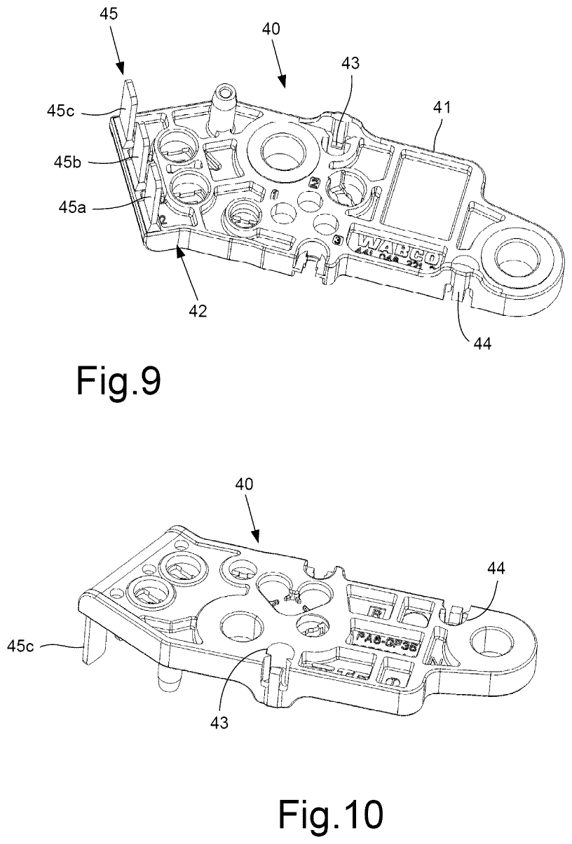

FIG. 9 and FIG. 10 show a second adapter 40 from its upper side and underside. The second adapter 40 has a plate 41 with an extension 42, which protrudes beyond the carrier 5, as it were extends it. The plate 41 has two receptacles 43, 44 for the detent pins 18, 19 of the carrier 5 and, as in the case of the first adapter 35, can be locked in place on the carrier 5 by way of the second retaining feature 17. Arranged in the extension 42 of the plate 41 is an electrical plug-in contact device 45. The electrical plug-in contact device 45 has three plug-in contacts 45a, 45b, 45c, which corresponds to the number of contact springs 32a, 32b, 32c of the electrical spring contact device 31. Each plug-in contact 45a, 45b, 45c is electrically connected in each case to an electrical contact spring 32a, 32b, 32c in the fitted state of the adapter 40. By way of the second adapter 40, the pressure measuring module 1 or the pressure sensor 20 can be electrically connected to a plug-in connection of the pneumatic device 2 or to a control device 3 of the pneumatic device 2, for example to a plug-in connection of a cable harness.

### LIST OF REFERENCE NUMERALS (PART OF THE DESCRIPTION)

1 Pressure measuring module
2 Pneumatic device of an automated manual transmission
3 Electronic control device of the pneumatic device
4 Mechanical interface of the pressure measuring module
5 Carrier of the pressure measuring module
6 First retaining feature of the carrier
7 First extension of the first retaining feature
8 First through-bore of the first retaining feature
9 Second extension of the first retaining feature
10 Second through-bore of the first retaining feature
11 First sleeve in the first through-bore
12 Second sleeve in the second through-bore
13 First threaded screw in the first through-bore
14 Second threaded screw in the second through-bore
15 First carrier side
16 Second carrier side
17 Second retaining feature of the carrier
18 First detent pin of the second retaining feature, connecting element
19 Second detent pin of the second retaining feature, connecting element
20 Pressure sensor of the pressure measuring module
21 Membrane of the pressure sensor
22 Circuit board of the pressure sensor
23 Pneumatic opening of the pressure sensor
24 Evaluation electronics of the pressure sensor
25 Covering of the pressure sensor
26 Pneumatic interface of the pressure measuring module
27 Pneumatic sealing feature of the pneumatic interface, O-ring
28 Groove for the O-ring in the carrier
30 Electrical interface of the pressure measuring module
31 Electrical spring contact device of the electrical interface
32a First contact spring of the electrical spring contact device
32b Second contact spring of the electrical spring contact device
32c Third contact spring of the electrical spring contact device
35 First adapter for the pressure measuring module
36 Cover of the first adapter
37 First receptacle of the first adapter for the first detent pin
38 Second receptacle of the first adapter for the second detent pin
39 Pressure signal transmitter
40 Second adapter for the pressure measuring module
41 Plate of the second adapter
42 Extension of the plate
43 First receptacle of the second adapter for the first detent pin
44 Second receptacle of the second adapter for the second detent pin
45 Electrical plug-in contact device of the second adapter
45a First plug-in contact of the plug-in contact device
45b Second plug-in contact of the plug-in contact device
45c Third plug-in contact of the plug-in contact device

1. A pressure measuring module (1) for a pneumatic device (2) of a vehicle, the pressure measuring module (1) comprising:
a pressure sensor (20),
a mechanical interface (4) configured to mechanically connect the pressure sensor (20) to the pneumatic device (2) directly or indirectly,
a pneumatic interface (26) that records a pneumatic pressure of the pneumatic device (2), and
an electrical interface (30) that passes on an electrical pressure measuring signal concerning the recorded pneumatic pressure and generated by the pressure sensor (20)
wherein the mechanical interface (4) includes a plate-shaped carrier (5),
wherein the pressure sensor (20) is arranged on the plate-shaped carrier (5),
wherein the carrier (5) includes at least a first retaining feature (6) configured to mechanically connect means the carrier (5) to an associated retaining of the pneumatic device (2),
wherein the first retaining feature (6) includes at least two extensions (7, 9), formed on the carrier (5) and respectively provided with a through-bore (8, 10), in that
wherein the extensions (7, 9) of the carrier (5) are spaced from one another and from the pressure sensor (20),
wherein the pneumatic interface (26) is arranged on a first carrier side (15),
wherein the pneumatic interface (26) protrudes from the first carrier side (15) and is provided with a sealing feature (27) such that, when mechanically connecting the carrier (5) to the pneumatic device (2), a pressure-tight connection of the pneumatic interface (26) to the pneumatic device (2) is established,
wherein the electrical interface (30) is arranged on a second carrier side (16), which is opposite from the first carrier side (15),
wherein the electrical interface (30) includes an electrical spring contact device (31), which protrudes from the second carrier side (16) and which has at least one electrical contact spring (32a, 32b, 32c) formed as a compression spring, and
wherein the electrical interface (30) is configured to electrically connect to an electronic control device (3) of the pneumatic device (2) directly or indirectly by way of an adapter (35, 40).

2. The pressure measuring module as claimed in claim 1, wherein the electrical spring contact device (31) is arranged off-center on the second carrier side (16), and wherein the spring contact device (31) has three electrical contact springs (32a, 32b, 32c), which are arranged in the shape of a triangle and are formed as helical compression springs or spiral compression springs and which in their axial extent protrude from the second carrier side (16).

3. The pressure measuring module as claimed in claim 1,
wherein the carrier (5) has a second retaining feature (17) configured to mechanically connect the carrier (5) to a retaining feature (37, 38, 43, 44) of an adapter (35, 40) for the electrical interface (30),
wherein the second retaining feature (17) has at least two detent pins (18, 19) or connecting elements, which are spaced from one another and from the pressure sensor (20),
wherein the mechanical connection of the carrier (5) to the adapter (35, 40) by the second retaining feature (17; 18, 19) establishes an electrical connection of the electrical interface (30) to the adapter (35, 40).

4. The pressure measuring module as claimed in claim 3,
wherein a first adapter (35) is formed as a transmitter connection,
wherein the first adapter (35) has a cover (36), configured to be fastened on the second retaining feature (17; 18, 19) of the carrier (5), and
wherein a pressure signal transmitter (39) which is electrically connected to the electrical spring contact device (31) in the fitted state is integrated in the cover (36).

5. The pressure measuring module as claimed in claim 3,
wherein a second adapter (40) is formed as a plug connection,
wherein the second adapter (40) has a plate (41), configured to be fastened on the second retaining means (17; 18, 19) of the carrier (5),
wherein the plate (41) has an extension (42) extending geometrically beyond the carrier (5),
wherein an electrical plug-in contact device (45) is arranged on the extension (42),
wherein the plug-in contact device (45) has at least a number of electrical plug-in contacts (45a, 45b, 45c) corresponding to the number of electrical contact springs (32a, 32b, 32c) of the spring contact device (31), and
wherein in the fitted state in each case at least one plug-in contact (45a, 45b, 45c) is electrically connected to a contact spring (32a, 32b, 32c).

6. The pressure measuring module as claimed in claim 1, wherein the pressure sensor (20) is formed as a piezoelectric microsensor with a pressure-sensitive piezoresistive membrane (21) and with evaluation electronics (24), wherein the evaluation electronics (24) are electrically connected to the electrical spring contact device (31), and wherein the membrane (21) is pneumatically connected to the pneumatic interface (26).

7. The pressure measuring module as claimed in claim 1, wherein the pressure sensor (20) is releasably fastened on the carrier (5) as a module part.

8. A pneumatic device (2) of a vehicle which serves for the actuation of switching actuators and or selecting actuators of an automated manual transmission, with an electropneumatic switching device and with a pressure measuring module (1) for recording a pneumatic pressure of the switching device, with the pressure measuring module (1) being constructed as claimed in claim 1.

9. A vehicle, such as a commercial vehicle or passenger car, with a pressure measuring module (1) for measuring a pneumatic pressure of a pneumatic device (2) of the vehicle, with the pressure measuring module (1) being constructed as claimed in claim 1.

10. The pressure measuring module as claimed in claim 6, wherein the pressure sensor (20), wherein the microsensor includes multiple piezoresistors interconnected to form a Wheatstone bridge.

11. The pressure measuring module as claimed in claim 6, wherein the membrane is disposed at the end of a pneumatic opening (23) or bore in the carrier, which is part of the pneumatic interface (26).

12. The pressure measuring module as claimed in claim 11, wherein the pneumatic interface is formed as a cylindrical body that axially protrudes out of the first carrier side.

13. The pressure measuring module as claimed in claim 12, wherein the pneumatic sealing feature is an o-ring that annularly surrounds the opening (23).

14. The pressure measuring module as claimed in claim 12, wherein the o-ring is disposed in a groove of the carrier.

15. The pressure measuring module as claimed in claim 3, wherein the detent pins project axially from the second carrier side (16).

16. The pressure measuring module as claimed in claim 12, wherein the sensor (20) is disposed at an axially opposite end of the cylindrical body from the pneumatic sealing feature (26).
